(19) United States
(12) Patent Application Publication
(10) Pub. No.: US 2024/0033726 A1
(43) Pub. Date: Feb. 1, 2024

(54) WAFER FOR CARRYING BIOLOGICAL SAMPLE

(71) Applicant: OXFORD IMMUNE ALGORITHMICS LTD, Reading (GB)

(72) Inventors: Hector Zenil, Reading (GB); Jürgen Hermann Richard Riedel, Reading (GB); Isaac Gerald Frederick Jones, Reading (GB)

(21) Appl. No.: 18/268,524

(22) PCT Filed: Dec. 20, 2021
(86) PCT No.: PCT/GB2021/053376

§ 371 Date: Jun. 20, 2023

Related U.S. Application Data
(63) Continuation of application No. 17/498,132, filed on Oct. 11, 2021, now Pat. No. 11,534,751.

(30) Foreign Application Priority Data
Dec. 22, 2020 (GB) 2020375.8

(51) Int. Cl. B01L 3/00; G01N 1/00

(52) U.S. Cl. CPC B01L 3/502; G01N 1/00; G01N 2001/002; B01L 2300/0803; B01L 2400/0406

(57) ABSTRACT

A wafer for carrying a biological sample, the wafer comprising: a pair of circular discs, wherein at least one of the discs is transparent; and a gap between the discs adapted to receive a biological sample. The compact circular shape of the wafer makes it particularly suited for use in a portable device in which the wafer is rotated to enable a camera to image different areas of the sample between the discs. The gap may be sized to pull a biological sample into the gap by capillary action.

### FIELD OF THE INVENTION

The present invention relates to a wafer for carrying a biological sample, a method of manufacturing such a wafer, a method of loading a sample into such a wafer and a method of imaging a sample in such a wafer.

The term “wafer” is used herein to refer to a sample carrier which may or may not have a circular periphery.

### BACKGROUND

Conventional systems and methods for biological imaging usually require a microscopic setup operated by humans traversing slides in translational movements, or a very expensive technique such as spectroscopy, flow-cytometry, electrical impedance, or chemical assays. Such technologies are unaffordable for applications of high population impact. Such systems and methods also do not scale and generalise well as they require manual analysis and are based on expensive optics and often provide inaccurate or incompatible results. Translational movement requires room to scan the same sample and makes it difficult for the design of a portable device with limited space.

### SUMMARY OF THE INVENTION

A first aspect of the invention provides a wafer for carrying a biological sample, the wafer comprising: a pair of circular discs, wherein at least one of the discs is transparent; and a gap between the discs adapted to receive a biological sample.

The compact circular shape of the wafer makes it particularly suited for use in a portable device in which the wafer is rotated to enable a camera to image different areas of the sample between the discs.

Optionally the gap is sized to pull a biological sample into the gap by capillary action.

Optionally one of the discs has an opening which provides an inlet into the gap. This may help to load more of the sample into gap, or may help break the surface tension of the sample which make it easier to introduce into the gap. One or more vent holes may also be provided in one of the discs.

The opening may comprise a through-hole which extends through a thickness of the one of the discs. Alternatively the opening may comprise a recess, notch or channel in an edge of the one of the discs.

Optionally a first one of the circular discs has the opening which provides the inlet into the gap, the opening comprises an inlet recess in a face of the first one of the circular discs, and the inlet recess extends to an edge of the first one of the circular discs.

A second aspect of the invention provides a wafer for carrying a biological sample, the wafer comprising: a pair of plates, wherein at least one of the plates is transparent; and a gap between the plates adapted to receive a biological sample, wherein a first one of the plates has an opening which provides an inlet into the gap, the opening comprises an inlet recess in a face of the first one of the plates.

Optionally the first one of the plates and/or the second one of the plates is a disc which is circular around at least a majority of its circumference. Alternatively one or both of the plates may have a non-circular edge, such as a rectangular edge.

Optionally the inlet recess extends to an edge of the first one of the discs or plates.

Optionally a first one of the discs or plates is formed with a sample recess, and the inlet recess comprises an inlet well extending from the sample recess to an end wall of the inlet well.

Optionally the inlet recess has an outer end at the edge of the first one of the discs or plates; an inner end opposite the outer end; a base which runs between the outer end and the inner end; and an open side opposite the base.

Optionally the inlet recess comprises a tapered recess which becomes progressively shallow away from the edge of the first one of the discs or plates.

The inlet recess may become progressively shallow along its full radial extent, or along only part of its radial extent.

Optionally the inlet recess extends radially.

Optionally a second one of the discs or plates has a face which is un-recessed where it faces the inlet recess.

Optionally the inlet recess is a first inlet recess, the wafer further comprises a second inlet recess in a face of the second one of the discs or plates, and the second inlet recess is aligned with the first inlet recess.

The gap may have a substantially constant size, for instance varying across the wafer by less than 10%. Alternatively a size of the gap may vary substantially across the wafer, for instance by more than 30% or more than 50%.

A size of the gap (for instance a mean size of the gap, a maximum size of the gap, a size of the gap at an outer periphery of the gap, or a size of the gap where the inlet meets the gap) may be less than 200 μm, less than 100 μm, less than 50 μm, less than 20 μm, less than 15 μm or less than 10 μm.

A size of the gap (for instance a mean size of the gap, a maximum size of the gap, a size of the gap at an outer periphery of the gap, or a size of the gap where the inlet meets the gap) may be greater than 1 μm or greater than 2 μm.

A size of the gap (for instance a mean size of the gap, a maximum size of the gap, a size of the gap at an periphery of the gap, or a size of the gap where the inlet meets the gap) may be greater than 2 μm and less than 10 μm, making it suitable for carrying a cell multilayer of whole blood.

A size of the gap (for instance a mean size of the gap, a maximum size of the gap, a size of the gap at an outer periphery of the gap, or a size of the gap where the inlet meets the gap) may be or greater than 2 μm and less than Sum, making it suitable for carrying a cell monolayer of whole blood.

Optionally the wafer further comprises an inlet into the gap.

Optionally the inlet is at an edge of the wafer, and/or at an edge of the gap.

Optionally the inlet is configured to enable the biological sample to flow through the inlet in a radial direction, towards a centre of the wafer.

Optionally the inlet comprises a channel which extends in a radial direction, towards a centre of the wafer.

Optionally an inner face of a lower one of the discs or channels provides a ledge adjacent to the inlet.

Optionally the discs have circular edges which overlap with each other except at the inlet where an inner face of a lower one of the discs provides a ledge adjacent to the inlet.

Optionally the wafer further comprises one or more spacers between the discs or plates.

Optionally the one or more spacers comprise an adhesive tape.

Optionally the one or more spacers comprise a spacer with an opening which provides an inlet into the gap. Optionally the spacer comprises a ring which is broken by the opening.

Optionally the one or more spacers control the size of the gap.

Optionally the one or more spacers comprise three or more spacers.

Optionally the gap extends across a full diameter of the wafer.

Optionally the gap comprises a sample chamber adapted to receive the biological sample.

Optionally the sample chamber comprises an edge wall which provides a boundary of the sample chamber at its outer edge. The edge wall may be provided by a spacer; or by a wall of a recess in one of the discs or plates, for example.

Optionally the wafer further comprises an inlet for loading the biological sample into the sample chamber. Optionally the inlet comprises an opening in the edge wall of the sample chamber.

A further aspect of the invention provides a wafer for carrying a biological sample, the wafer comprising: a pair of plates, wherein at least one of the plates is transparent; a sample chamber between the plates adapted to receive a biological sample; and an inlet for loading the biological sample into the sample chamber, wherein the sample chamber comprises an edge wall which provides a boundary of the sample chamber at its outer edge, and the inlet comprises an opening in the edge wall of the sample chamber.

Optionally the wafer further comprises a sample recess in an inner face of a first one of the discs or plates, the sample recess providing at least part of the gap.

Optionally the wafer further comprises an adhesive which secures the discs or plates together.

Optionally each disc or plate has a circular periphery at an edge of the wafer.

Optionally the discs or plates are welded or adhered together.

Optionally the discs or plates have opposed parallel planar surfaces on opposite sides of the gap.

Optionally the gap contains a stain, dye or other reagent.

Optionally a size of the gap varies in a radial direction away from a centre of the wafer.

Both of the discs or plates may be transparent, or one of the discs or plates may be opaque or reflective.

The gap may have a circular open outer periphery at an edge of the wafer. This may enable the sample to be introduced into the gap via the open outer periphery. Alternatively, air may escape the outer periphery of the gap as the sample is introduced into the gap at a centre of the wafer or other location.

The circular open outer periphery of the gap may extend around all or most of a circumference of the wafer.

A further aspect of the invention provides a wafer for carrying a biological sample, the wafer comprising: a pair of circular discs, wherein at least one of the discs is transparent; and a gap between the discs adapted to receive a biological sample, wherein a size of the gap varies in a radial direction away from a centre of the wafer.

Optionally the size of the gap increases in the radial direction away from the centre of the wafer.

Optionally the size of the gap increases in the radial direction to a maximum at a periphery of the gap at an edge of the wafer.

Optionally the pair of circular discs comprise an upper disc and a lower disc, and the upper disc is sagged at the centre of the wafer or drooped at an edge of the upper disc.

Optionally a first one of the discs has a frustoconical surface on a first side of the gap; and a second one of the discs may have a planar surface on a second opposite side of the gap.

Optionally the gap comprises a sample chamber, the size of the gap varies in the sample chamber from a maximum gap size to a minimum gap size, and a ratio between the maximum and minimum gap sizes is greater than 1.1, greater than 1.3 or greater than 1.5.

Optionally the gap comprises a sample chamber, and the size of the gap varies monotonically in the radial direction in the sample chamber.

A further aspect of the invention provides a wafer for carrying a biological sample, the wafer comprising: a pair of circular discs, wherein at least one of the discs is transparent; and a gap between the discs adapted to receive a biological sample, wherein one of the discs has an opening which provides an inlet into the gap, and the opening comprises a recess, notch or channel in an edge of the one of the discs.

A further aspect of the invention provides a method of loading a biological sample into a wafer according to any preceding aspect, the method comprising introducing the sample into the gap so that the sample is pulled into the gap by capillary action.

Optionally the sample is pulled into the gap by capillary action to form a cell monolayer.

Optionally one of the discs has an opening which provides an inlet into the gap, and the sample is introduced into the gap via the opening.

The gap may be an air gap, or it may contain a stain, dye or reagent wherein the sample comes into contact with the stain, dye or reagent as it is pulled into the gap.

Optionally the discs may be joined together. For instance the discs may be bonded together by an adhesive, welded together by controlled melting; or joined together by a fastener such as rod which passes through one of the discs with an interference fit.

The discs may have opposed parallel planar surfaces on opposite sides of the gap.

Optionally the sample is introduced into the gap via an inlet. The inlet is typically at an edge of the wafer and/or at an edge of the gap.

Optionally the sample flows in a radial direction through the inlet, towards a centre of the wafer.

Optionally the gap comprises a chamber adapted to receive the biological sample, the sample chamber comprises an edge wall which provides a boundary of the sample chamber at its outer edge, and the sample is introduced into the gap via an inlet in the edge wall of the sample chamber.

The edge wall may be provided by a spacer, or by a wall of a recess in one of the discs or plates, for example.

Optionally the method further comprises spinning the wafer to pre-sort molecular elements in the wafer.

A further aspect of the invention provides a method of manufacturing a wafer according to any preceding aspect, the method comprising bringing the discs or plates together to provide the gap between the discs; and fixing the discs or plates together.

Optionally the discs or plates are fixed together by welding, with an adhesive or with an interference-fit fastener.

Optionally the wafer comprises an upper disc or plate, and a lower disc or plate with one or more spacers which control the size of the gap, the discs or plates being held together by an adhesive; wherein when the discs or plates are brought together, the adhesive spreads out until the one or more spacers contact an underside of the upper disc or plate; and the adhesive is then cured to secure the discs or plates together.

Optionally the method further comprises printing one or more spacers on one of the discs or plates, wherein the one or more spacers control a size of the gap.

Optionally the method further comprises deforming one of the discs or plates so that a size of the gap varies across the wafer.

A further aspect of the invention provides a method of imaging a biological sample, the method comprising loading the biological sample into a wafer by the method of the preceding aspect, then imaging the biological sample in the gap.

Optionally the wafer is rotated between a series of orientations, each orientation bringing a different area of the biological sample into a field of view of a camera.

### DESCRIPTION OF THE FIGURES

FIG. 1 is a plan view of a wafer;

FIG. 2 is an isometric view of the wafer of FIG. 1;

FIG. 3 shows a gap between the discs;

FIG. 4 shows a pair of discs of a wafer with spacers;

FIG. 5 shows a pair of discs of a wafer with spacers and a joining rod;

FIG. 6 shows the discs of FIG. 5 in their assembled state;

FIG. 7 is a cross-section along a line A-A;

FIG. 8 shows a pair of discs of a wafer with three joining rods;

FIG. 9 shows the discs of FIG. 8 in their assembled state;

FIG. 10 is a cross-section along a line B-B;

FIG. 11 shows a pair of discs of a wafer with a central joining rod;

FIG. 12 shows the discs of FIG. 11 in their assembled state;

FIG. 13 is a cross-section along a line C-C;

FIG. 14 shows a pair of discs of a wafer with three spacers and an adhesive;

FIG. 15 shows the discs of FIG. 14 in their pre-assembly state;

FIG. 16 is a cross-section along a line D-D;

FIG. 17 shows a pair of discs of a wafer with an inlet at its edge;

FIG. 18 shows the discs of FIG. 17 in their assembled state;

FIG. 19 is a side view of the wafer of FIG. 18;

FIG. 20 shows hidden internal parts of the wafer of FIG. 18;

FIG. 21 shows the wafer of FIG. 18 with a section line E-E;

FIG. 22 is a cross-section along the line E-E;

FIG. 23 is a plan view of a wafer with a through-hole inlet at its edge;

FIG. 24 is an isometric view of the wafer of FIG. 23;

FIG. 25 is a side view of the wafer of FIG. 23;

FIG. 26 shows hidden internal parts of the wafer of FIG. 24;

FIG. 27 shows the wafer of FIG. 18 with a section line E-E;

FIG. 27 shows the pair of discs in an unassembled state;

FIG. 28 shows the wafer of FIG. 24 with a section line F-F;

FIG. 29 is a cross-section along the line F-F;

FIG. 30 shows a pair of discs of a wafer with a through-hole inlet and set of channels;

FIG. 31 shows hidden internal parts of the wafer;

FIG. 32 shows the wafer of FIG. 31 with a section line G-G;

FIG. 33 is a cross-section along the line G-G;

FIG. 34 shows a pair of discs of a wafer with an edge channel;

FIG. 35 shows hidden internal parts of the wafer;

FIG. 36 shows the wafer of FIG. 35 with a section line H-H;

FIG. 37 is a cross-section along the line H-H;

FIG. 38 shows a pair of discs for assembling a wafer with a varying sized gap;

FIG. 39 shows a disassembled wafer having a spacer with a pair of annular steps;

FIG. 40 shows another disassembled wafer having a spacer with a pair of annular steps;

FIG. 41 shows the wafer of FIG. 40 in its assembled state;

FIG. 42 is a cross-section along the line I-I;

FIG. 43 shows a disassembled wafer having three spacers with annular steps;

FIG. 44 shows the wafer of FIG. 43 in its assembled state;

FIG. 45 is a cross-section along the line J-J;

FIG. 46 is a plan view of a wafer;

FIG. 47 is a side view of the wafer;

FIG. 48 is a cross-sectional view showing parts of the wafer before assembly;

FIG. 49 shows an upper face of the lower disc;

FIG. 50 shows a lower face of the upper disc;

FIG. 51 shows an optional adhesive spacer;

FIG. 52 is a cross-section taken along a line A-A in FIG. 46;

FIG. 53 is a plan view of a wafer;

FIG. 54 is a side view of the wafer;

FIG. 55 is a cross-sectional view showing parts of the wafer before assembly;

FIG. 56 shows an upper face of the lower disc;

FIG. 57 shows a lower face of the upper disc;

FIG. 58 shows an adhesive spacer;

FIG. 59 is a cross-section taken along a line B-B in FIG. 53;

FIG. 60 is a plan view of a wafer;

FIG. 61 is a side view of the wafer;

FIG. 62 shows an upper face of the lower disc;

FIG. 63 is a cross-sectional view showing parts of the wafer before assembly;

FIG. 64 shows a lower face of the upper disc;

FIG. 65 is a cross-section taken along a line C-C in FIG. 60;

FIG. 66 is a plan view of a wafer;

FIG. 67 is a side view of the wafer;

FIG. 68 is a cross-sectional view showing parts of the wafer before assembly;

FIG. 69 shows an upper face of the lower disc;

FIG. 70 shows a lower face of the upper disc;

FIG. 71 is a cross-section taken along a line D-D in FIG. 66;

FIG. 72 is a plan view of a wafer;

FIG. 73 is a side view of the wafer;

FIG. 74 is a cross-sectional view showing parts of the wafer before assembly;

FIG. 75 shows an upper face of the lower disc;

FIG. 76 shows a lower face of the upper disc;

FIG. 77 is a cross-section taken along a line E-E in FIG. 72;

FIG. 78 is a plan view of a wafer;

FIG. 79 is a side view of the wafer;

FIG. 80 shows an upper face of the lower disc;

FIG. 81 is a cross-section taken along a line F-F in FIG. 78;

FIG. 82 is a plan view of a wafer;

FIG. 83 is a side view of the wafer;

FIG. 84 shows an upper face of the lower disc;

FIG. 85 is a cross-section taken along a line G-G in FIG. 82;

FIG. 86 is a plan view of a wafer;

FIG. 87 is a side view of the wafer;

FIG. 88 shows an upper face of the lower disc;

FIG. 89 is a cross-section taken along a line H-H in FIG. 86;

FIG. 90 shows a portable device for imaging a biological sample; and

FIG. 91 shows the portable device of FIG. 90 in a disassembled state along with a wafer and cartridge which can be inserted into the device.

### DETAILED DESCRIPTION OF THE FIGURES

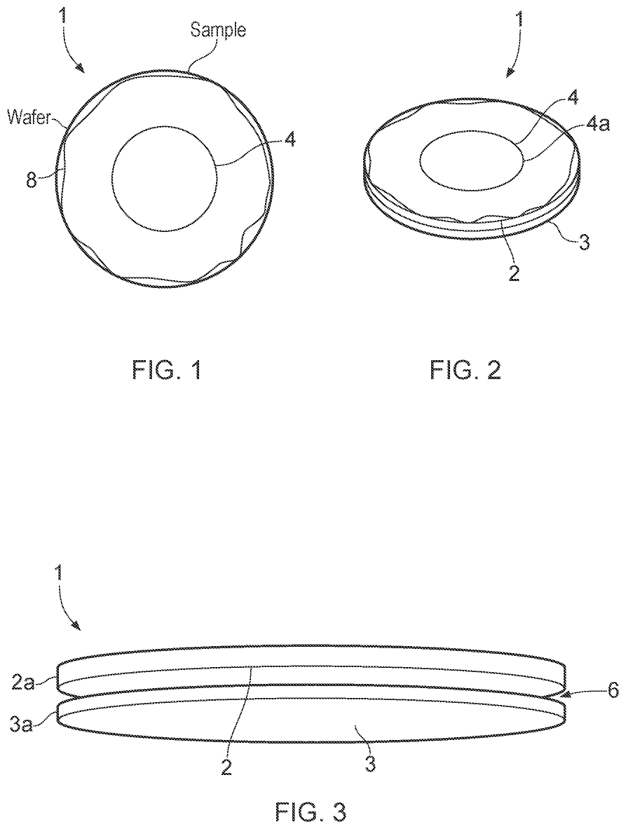

FIGS. 1-3 show a wafer 1 carrying a biological sample 8. The wafer comprises an upper disc 2 and a lower disc 2. A gap 6 between the discs is adapted to receive the biological sample 8.

A circular patch of adhesive tape 4 joins the lower face of the upper disc 2 to the upper face of the lower disc 3 at the centre of the wafer 1. The discs have circular peripheries 2a, 3a at an edge of the wafer 1. The diameter of the wafer may be between 2 cm and 5 cm, for example.

The discs are spaced apart so that the gap 6 provides an annular sample chamber around the adhesive tape. The gap 6 extends from an inner periphery at the circular periphery 4a of the adhesive tape 4 to an open circular outer periphery at the edge of the wafer 1.

The thickness of the tape 4 is carefully controlled so that the size of the gap 6 (as defined by the vertical spacing between the lower face of the upper disc 2 and the upper face of the lower disc 3) is between 2 μm and 5 μm at all points, including at the open circular outer periphery of the gap 6 at the edge of the wafer 1.

The size of the gap 6 is carefully selected so that a liquid biological sample introduced into the edge of the gap is drawn further into the chamber by the capillary effect to form a smear. FIG. 1 shows the edges of a smear 8 which almost completely fills the gap 6.

The size of the gap 6 is selected on the basis of the thickness of sample required. For example a monolayer smear may be preferred for a full blood test, whereas a thicker film may be preferred for a malaria test.

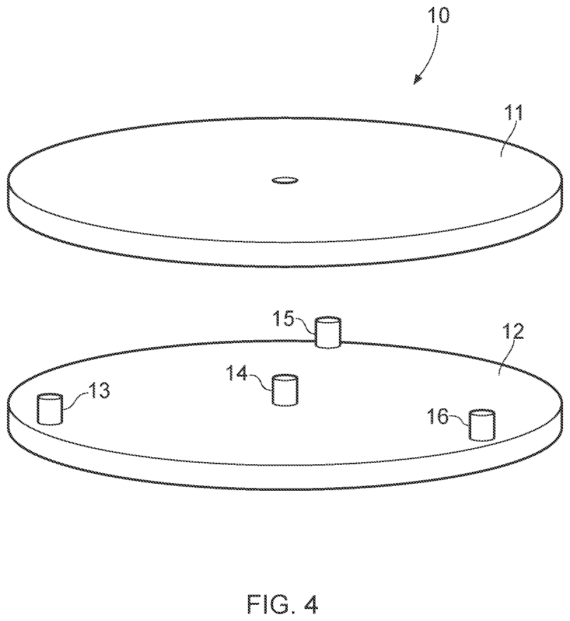

An alternative wafer 10 shown in FIG. 4 comprises a pair of circular discs 11, 12. FIG. 4 shows the discs before they are brought together to provide a gap between the discs. The lower disc 12 has four spacers 13-16 which control the size of the gap. When the discs are brought together, the spacers 13-16 contact the underside of the upper disc 11. The discs are held together by adhesive (not shown) on the top of the spacers 13-16.

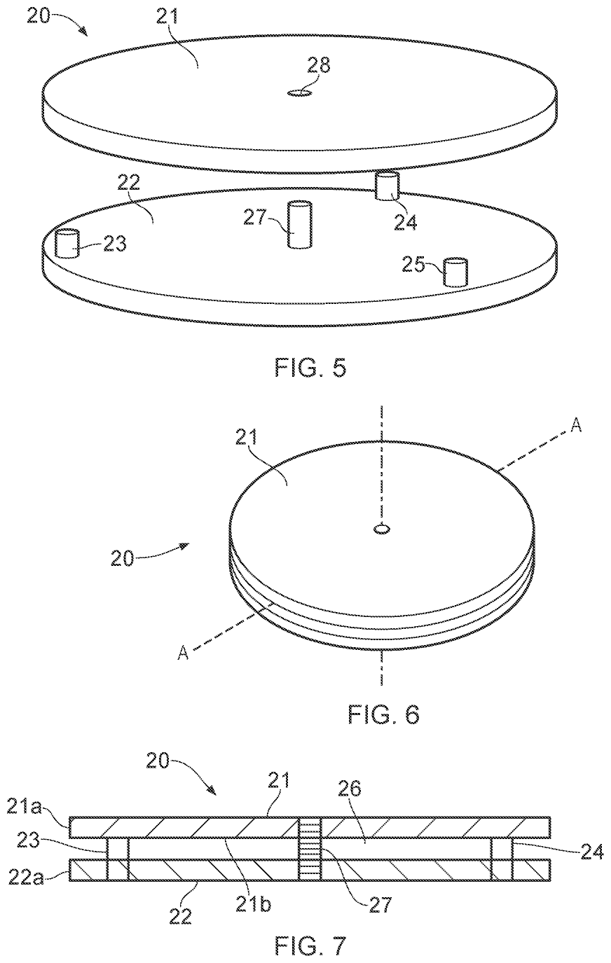

An alternative wafer 20 shown in FIGS. 5-7 comprises a pair of circular discs 21, 22 with circular edges 21a, 22a. FIG. 5 shows the discs before they are brought together to provide a gap 26 between the discs. The lower disc 22 has three spacers 23-25 which control the size of the gap 26. When the discs are brought together, the spacers 23-25 contact the underside 21b of the upper disc 21 as shown in FIG. 7. The discs are held together by a rod 27 which passes through a hole 28 in the upper disc 21 with an interference fit.

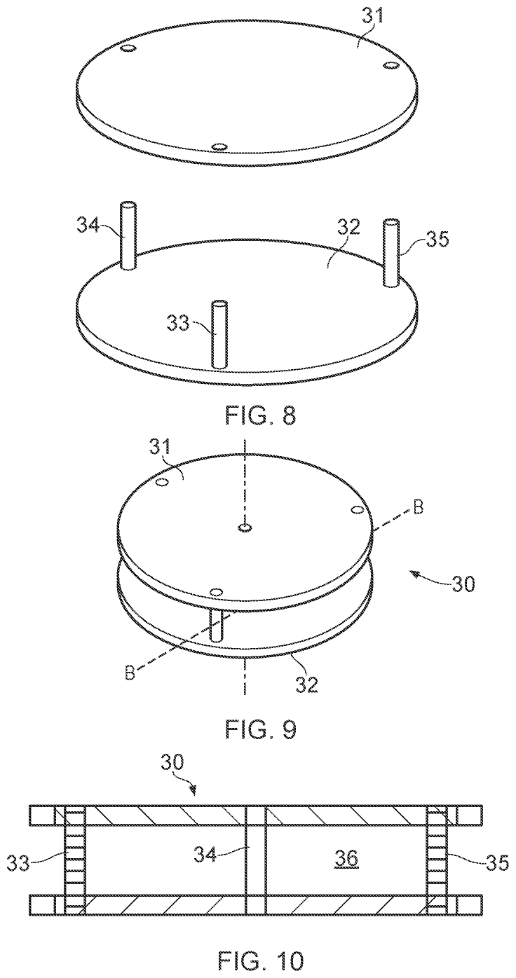

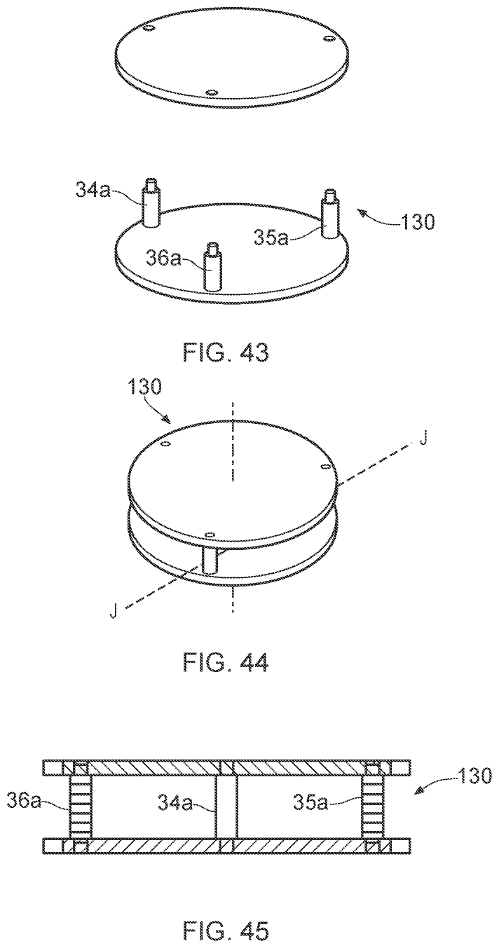

An alternative wafer 30 shown in FIGS. 8-10 comprises a pair of circular discs 31, 32. FIG. 8 shows the discs before they are brought together to provide a gap 36 between the discs. The lower disc 32 has three rods 33-35 which control the size of the gap 36. The rods 33-35 pass through respective holes in the upper disc 31 with an interference fit which holds the discs together. The size of the gap 36 may be controlled by forming the rods 33-35 with annular steps (not shown) which act as a stop. An example of a wafer 130 with rods 33a, 34a, 35a with such a pair of annular steps is shown in FIGS. 43-45.

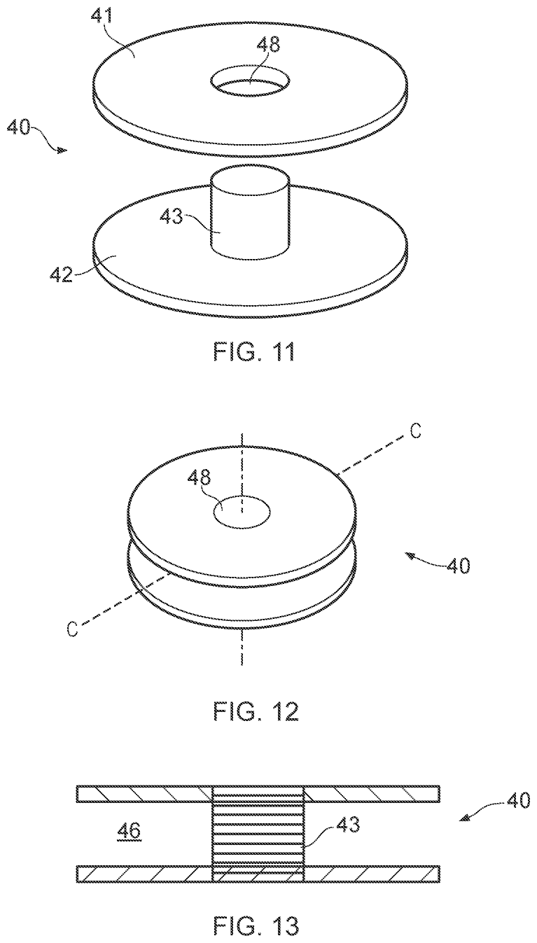

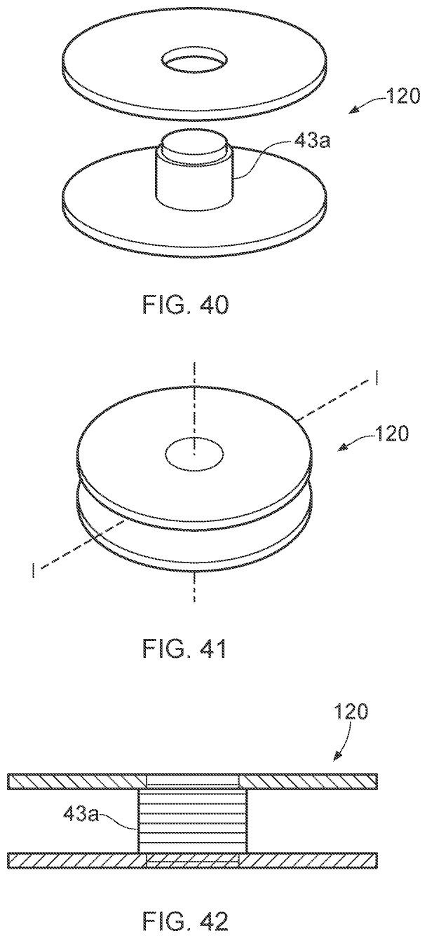

An alternative wafer 40 shown in FIGS. 11-13 comprises a pair of circular discs 41, 42. FIG. 11 shows the discs before they are brought together to provide a gap 46 between the discs. The lower disc 42 has a rod 43 which controls the size of the gap 46. The rod 43 passes through a hole 48 in the upper disc 41 with an interference fit which holds the discs together. The size of the gap 46 may be controlled by forming the rod 43 with an annular step which acts as a stop. An example of a wafer 120 with a central rod 43a with such an annular step is shown in FIGS. 40-42.

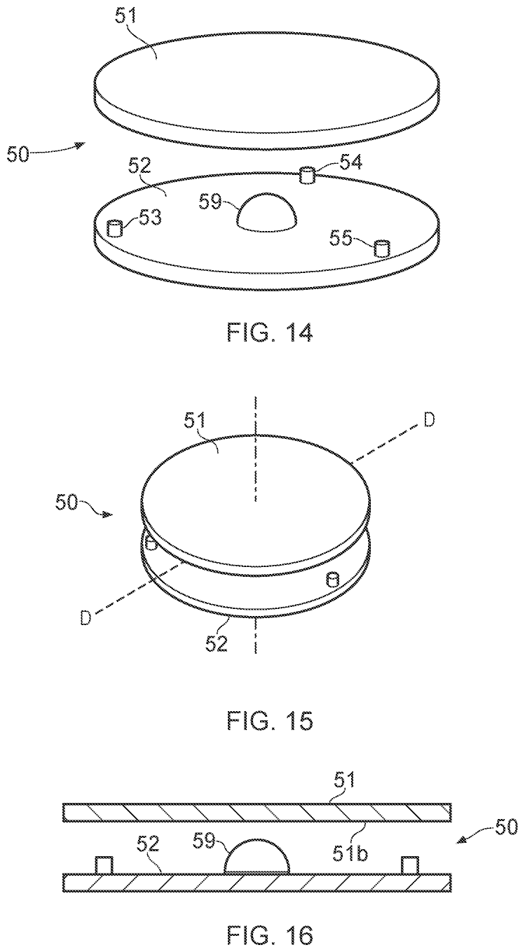

An alternative wafer 50 shown in FIGS. 14-16 comprises a pair of circular discs 51, 52. FIGS. 14-16 all show the discs before they are brought together to provide a gap between them. The lower disc 52 has three spacers 53-55 which control the size of the gap. When the discs are brought together, the spacers 53-55 contact the underside 51b of the upper disc 51.

The discs are held together by an adhesive 59. The adhesive 59 is shown in an uncured liquid state in FIGS. 14 and 16. When the discs are brought together, the adhesive 59 spreads out until the spacers 53-55 contact the underside 51b of the upper disc 51. The adhesive 59 is then cured to secure the discs together.

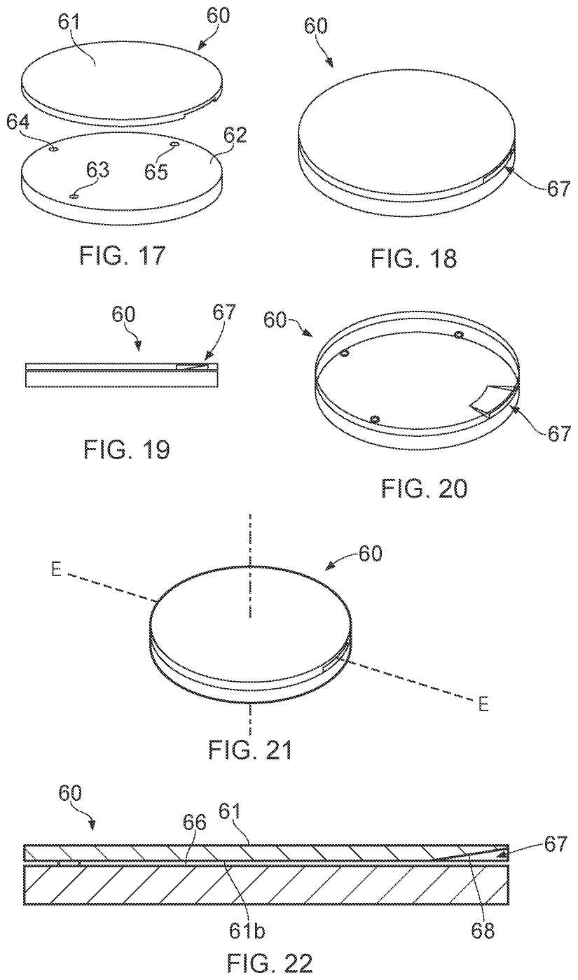

An alternative wafer 60 shown in FIGS. 17-22 comprises a pair of plates 61, 62 in the form of a pair of circular discs 61, 62. FIG. 17 shows the discs before they are brought together to provide a gap 66 between them. The lower disc 62 has three spacers 63-65 which control the size of the gap. When the discs are brought together, the spacers 63-65 contact the underside 61b of the upper disc 61.

A first one of the discs (in this case the upper disc 61, although it could be the lower disc 62) has an opening which provides an inlet 67 into the gap 66 as shown most clearly in FIG. 22.

The opening is in the form of a tapered inlet recess in the underside 61b of the upper disc 61. The tapered inlet recess has an angled face 68 shown in FIG. 22. The tapered inlet recess extends to an edge of the upper disc 61.

The tapered inlet recess becomes progressively shallow away from the edge of the upper disc 61. As shown in FIG. 22, the tapered inlet recess has a pair of ends: a relatively deep outer end at the edge of the upper disc 61; a relatively shallow inner end opposite the outer end; a base (the angled face 68) which runs between the outer end and the inner end, and an open lower side opposite the angled face 68 which faces the lower disc 62. The open lower side of the tapered inlet recess enables fluid to flow sideways out of the tapered inlet recess and into the gap 66 between the discs. Fluid can also flow radially into the gap 66 from the inner end of the tapered recess.

In the embodiment of FIGS. 17-22 the tapered inlet recess extends only part way to the centre of the upper disc 61. In other embodiments, the tapered recess may extend further, for instance to the centre of the upper disc 61.

In the embodiment of FIGS. 17-22 the tapered inlet recess becomes progressively and continuously shallower along its full radial extent, but in other examples it may only taper along part of its radial extent, or it may taper in a series of steps.

In the embodiment of FIGS. 17-22 each circular disc 61, 62 is a plate with an edge that is circular around a full circumference of the disc. In other embodiments, one or both of the circular discs 61, 62 may have an edge which is circular around a majority of the circumference of the disc, but flat or indented at certain places. For example the upper disc 61 may have a small flat or indent at the position of the inlet 67, so the upper face of the lower disc provides a ledge adjacent to the inlet 67.

In other embodiments, the circular discs 61, 62 may be replaced by plates with non-circular edges—for instance plates with octagonal edges, rectangular edges or any other shape.

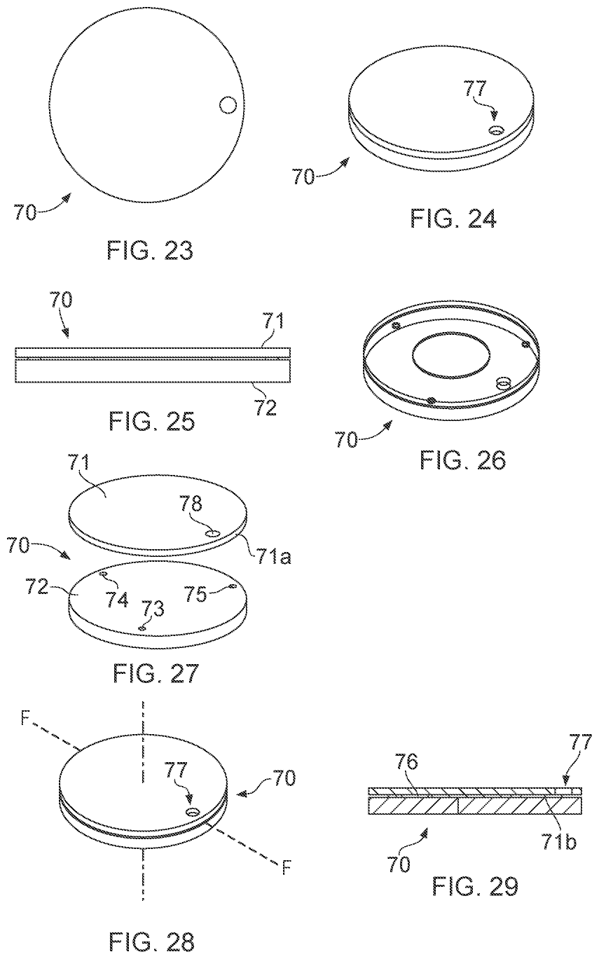

An alternative wafer 70 shown in FIGS. 23-29 comprises a pair of circular discs 71, 72. FIG. 27 shows the discs before they are brought together to provide a gap 76 between them. The lower disc 72 has three spacers 73-75 which control the size of the gap. When the discs are brought together, the spacers 73-75 contact the underside 71b of the upper disc 71.

One of the discs (in this case the upper disc 71, although it could be the lower disc 72) has an opening which provides an inlet 77 into the gap 76 as shown most clearly in FIG. 29. This inlet 77 helps to load more of the sample into gap 76, and helps break the surface tension of the sample which make it easier to introduce into the gap 76.

As shown in FIG. 27, the opening is in the form of a circular through-hole 78 which extends through a thickness of the upper disc 71 towards an edge 71a of the upper disc 71.

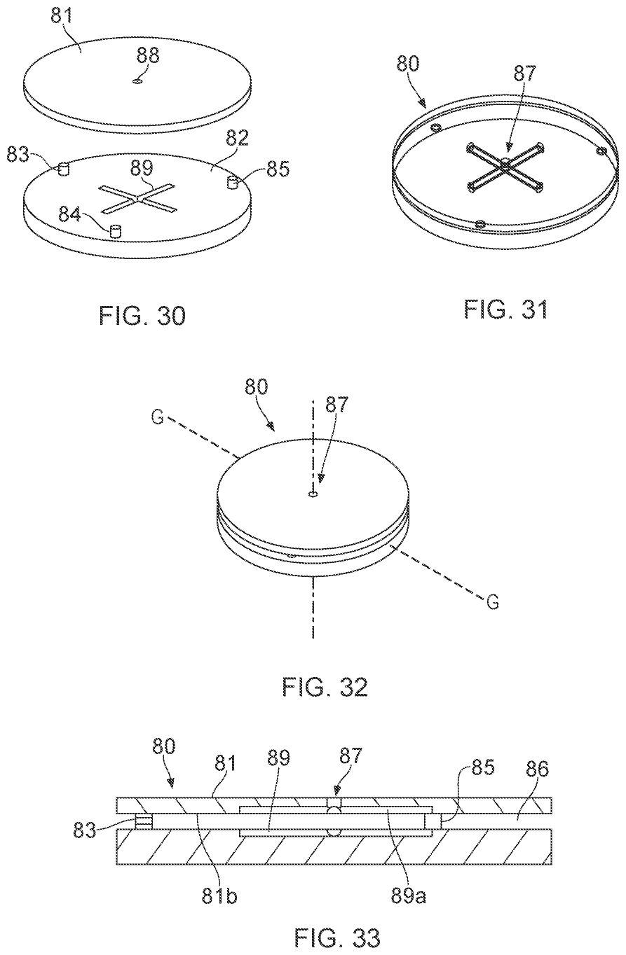

An alternative wafer 80 shown in FIGS. 30-33 comprises a pair of circular discs 81, 82. FIG. 30 shows the discs before they are brought together to provide a gap 86 between them. The lower disc 82 has three spacers 83-85 which control the size of the gap. When the discs are brought together, the spacers 83-85 contact the underside 81b of the upper disc 81 as shown in FIG. 33.

One of the discs (in this case the upper disc 81, although it could be the lower disc 82) has an opening which provides an inlet 87 into the gap 86 as shown most clearly in FIG. 33. This inlet 87 helps to load more of the sample into gap 86, and helps break the surface tension of the sample which make it easier to introduce into the gap 86.

As shown in FIG. 30, the opening is in the form of a circular drilled through-hole 88 which extends through a thickness of the upper disc 81 at the centre of the upper disc 81.

The upper face of the lower disc 82 is engraved with a set of semi-circular channels 89 shown in FIG. 30 which extend radially away from the centre of the disc 82. The lower face 81b of the upper disc 81 is engraved with a mirror-image set of semi-circular channels 89a shown in FIG. 33 which extend radially away from the through-hole 88 at the centre of the disc 82.

The sample is injected into the gap 86 via the inlet 87, and then flows from the inlet 76 along the channels 89, 89a and into the gap 86.

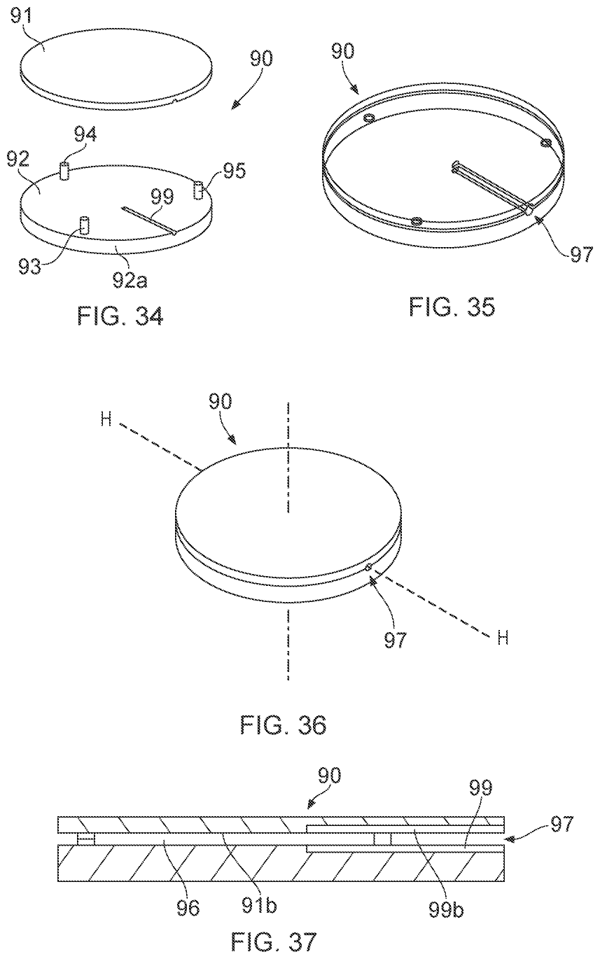

An alternative wafer 90 shown in FIGS. 34-37 comprises a pair of plates 91, 92. The plates 91, 92 are circular discs, comprising a first (lower) disc 92 and a second (upper) disc 91. FIG. 34 shows the discs before they are brought together to provide a gap 96 between them. The lower disc 92 has three spacers 93-95 which control the size of the gap. When the discs are brought together, the spacers 93-95 contact the underside 91b of the upper disc 91 as shown in FIG. 37.

The upper face of the lower disc 92 is engraved with a first semi-circular channel 99 shown in FIG. 34 which extends radially away from the centre of the disc 92 all the way to the edge 92a of the disc 92. The lower face 91b of the upper disc 91 is engraved with a second mirror-image semi-circular channel 99b shown in FIG. 37.

When the discs are brought together, the channels 99, 99b are aligned with each other and provide an inlet 97 with a generally circular cross-section as shown in FIGS. 35 and 36. The sample is injected into the gap 96 via the inlet 97.

Each channel 99, 99b is in the form of a notch or recess in a respective face of one of the discs. As shown in FIG. 37, each notch or recess has an outer end at the edge of the respective one of the discs; an inner end opposite the outer end; a rounded base which runs radially between the outer end and the inner end; and an open side opposite the rounded base.

The open side of the notch or recess enables fluid to flow sideways out of the channel 99, 99b and into the gap 96 between the discs. Fluid can also flow radially into the gap from the inner end of the channel 99, 99b.

The discs 91, 92 must be brought together with the correct relative angular orientation, so the channels 99, 99b are aligned with each other. The embodiment of FIG. 17-22 has an inlet 67 formed by an inlet recess in only one of the discs (the upper disc 61), the other one of the discs (the lower disc 62) having a face which is planar and un-recessed where it faces the inlet recess. This arrangement is beneficial for manufacturing purposes, because it means that the discs 61, 62 can be brought together with any relative angular orientation.

In the embodiment of FIGS. 34-37 each circular disc 91, 92 is a plate with an edge that is circular around a full circumference of the disc. In other embodiments, one or both of the circular discs may have an edge which is circular around a majority of the circumference of the disc, but flat or indented at certain places. For example each disc 91, 92 may have a small flat or indent at the position of the inlet 97. In other embodiments, the circular discs 91, 92 may be replaced by plates with non-circular edges—for instance octagonal edges, rectangular edges or any other shape.

In all of the examples shown above, the discs have opposed parallel planar surfaces on opposite sides of the gap. The size of the gap is ideally constant across the full diameter of the wafer, for example varying by less than 10% across the full diameter of the wafer.

The size of the gap is ideally tightly controlled, and typical gap sizes are given below in Table 1. Where the size of the gap varies across the wafer, then the size of the gap in Table 1 may refer to a mean size of the gap, a maximum size of the gap, a size of the gap at the open circular outer periphery of the gap, or a size of the gap where the inlet meets the gap.

TABLE 1

| Fluid | Feature | Purpose | Gap size |
|---|---|---|---|
| Whole blood | Capillary | Cell | Less than 20 μm or |
| | action | examination | less than 15 μm or |
| | and cell | and counting | less than 10 μm or |
| | monolayer | | less than 5 μm. |
| | | | More than 2 μm |
| Whole blood | Capillary | Less fine-grained | Less than 50 μm or |
| | action | purposes such as | less than 100 μm. |
| | and cell | Malaria detection | More than 2 μm |
| | multilayer | | |
| Other biological | Capillary | Multi-purpose | Less than 200 μm. |
| fluids (animal or | action | | More than 2 μm |
| human) | | | |

The gap is sized to pull a biological sample into the gap by capillary action. In the case of a sample of whole blood, blood cells have a thickness at their thickest point between 2 μm and 2.5 μm. So if the gap has a size less than 4 μm or Sum then the sample may be pulled into the gap by capillary action to form a cell monolayer.

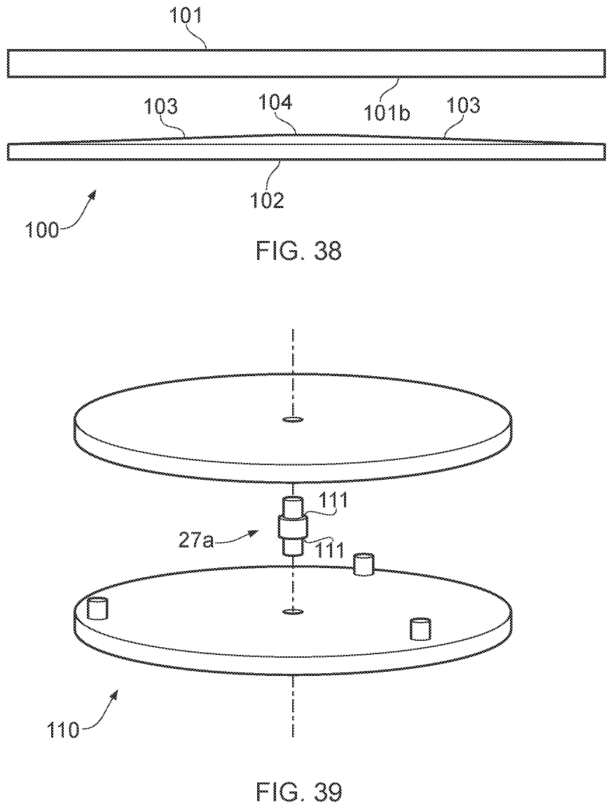

An alternative wafer 100 shown in FIG. 38 comprises a pair of circular discs 101, 102. FIG. 38 shows the discs before they are brought together to provide a gap between them.

The upper side of the lower disc 102 has a frustoconical surface 103 and a flat centre 104. The upper disc 101 has a flat underside 101b. When the discs are brought together, the flat centre 104 of the lower disc contacts the underside 101b of the upper disc. Spacers (not shown) may be provided to control the gap between the discs. The flat centre 104 may be joined to the underside 101b of the upper disc by adhesive, or other joining methods such as welding.

The frustoconical surface 103 results in a gap with a size which increases radially to a maximum at a circular open periphery of the gap at an edge of the wafer. The gap size increases monotonically away from the centre of the wafer, i.e. it increases without decreasing. The frustoconical surface 103 is rotationally symmetrical so the gap size does not vary circumferentially.

The gap may be sized so that only small cellular or molecular elements can fit into the narrow part of the gap at the centre (such as cells, proteins, antibodies, pathogens, or others) whereas larger cells can only fit into the wide part of the gap at the edge.

The wafer 100 may be spun to help pre-sort molecular elements in the wafer.

FIG. 39 shows a disassembled wafer having a central rod with a pair of annular steps. The wafer of FIG. 39 is similar to the wafer of FIGS. 5-7, the only difference being that the central rod 27a passes through a hole in the upper disc with an interference fit, and also passes through a hole in the lower disc with an interference fit. The central rod has a pair of annular steps 111 which act as stops against the upper and lower discs so the central rod 27a acts as a spacer.

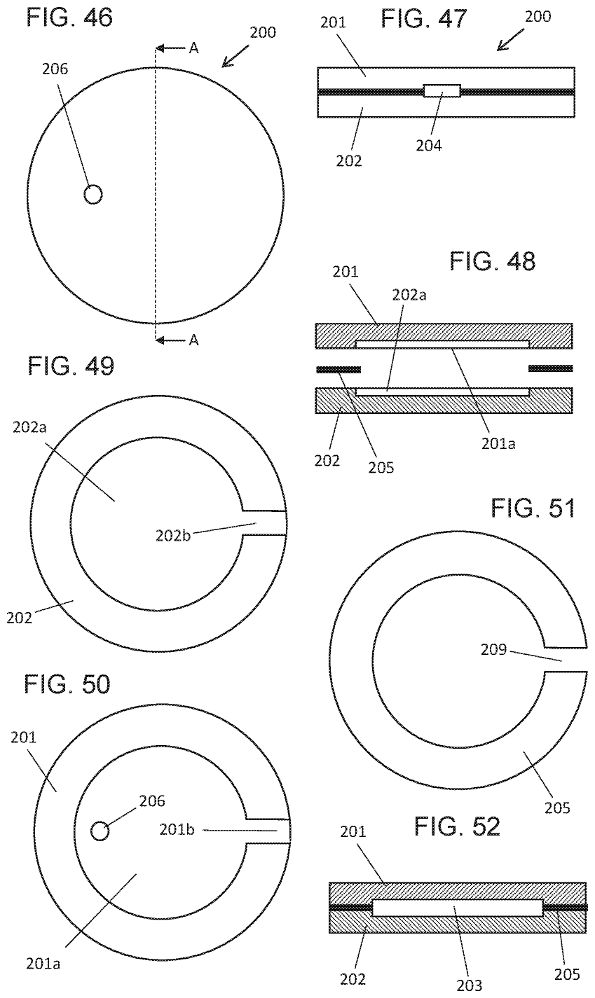

An alternative wafer 200 shown in FIGS. 46-52 comprises a pair of plates in the form of a pair of circular discs 201, 202. FIG. 48 shows the discs 201, 202 before they are brought together. The inner faces of the discs are shown in FIGS. 49 and 50.

The inner face of each disc is formed with a respective circular sample recess 201a, 202a, and a respective inlet recess 201b, 202b extending from an edge of the circular sample recess to the edge of the disc.

The sample recesses 201a, 202a and the inlet recesses 201b, 202b may be formed by etching (for instance laser cutting), by hot-embossing or by any other suitable process.

When the discs are brought together, the circular sample recesses 201a, 202a come together to form a sample chamber 203 shown in FIG. 52. Similarly the inlet recesses 201b, 202b come together to form an inlet 204 shown in FIG. 47 which runs from the outer edge of the sample chamber 203 to the edge of the wafer 200.

The cylindrical walls of the recesses 201a, 202a provide a boundary of the sample chamber 203, preventing the biological sample from leaking out of the outer edge of the sample chamber 203. The inlet recesses 201b, 202b provide an opening in the edge wall of the sample chamber 353 for introduction of the sample.

The discs may optionally be adhered to each other by a double-sided adhesive spacer 205. As shown in FIG. 51, the spacer 205 comprises a ring which extends round a majority of a circumference of the wafer. The ring is broken by a channel 209 which is aligned with the channels 201b, 202b so that the spacer 205 does not block the inlet 204 into the sample chamber 203.

In an alternative embodiment, the spacer 205 may be omitted and the inner faces of the discs joined together by ultrasonic welding or thermal welding.

The upper disc 201 has a vent hole 206 opposite the channel 201b. The vent hole 206 enables air to escape as a sample is introduced into the sample chamber 203 via the inlet 204.

The size of the gap between the discs in the sample chamber 203 is carefully selected so that a liquid biological sample introduced into the sample chamber 203 is drawn further into the sample chamber by the capillary effect to form a smear. This gap size is controlled by the combined depths of the circular recesses 201a, 202a and the thickness of the spacer 205. Suitable gap sizes are given in Table 1.

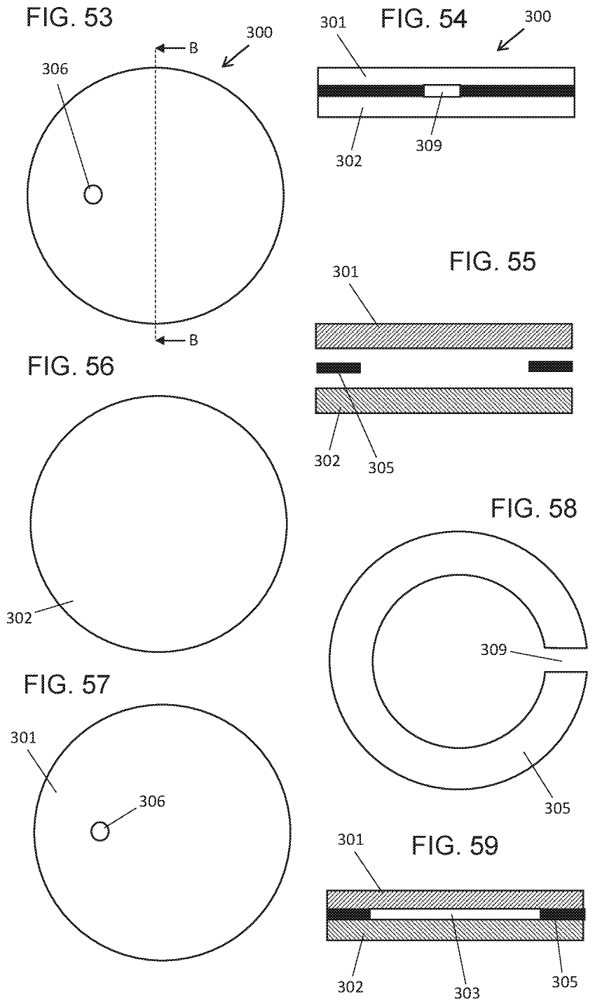

An alternative wafer 300 shown in FIGS. 53-59 comprises a pair of plates in the form of a pair of circular discs 301, 302. FIG. 55 shows the discs 301, 302 before they are brought together. The inner faces of the discs are shown in FIGS. 56 and 57. Unlike the previous embodiment, the inner faces of the discs are planar with no embossed or etched recesses or channels.

The discs are adhered to each other by a double-sided adhesive spacer 305. As shown in FIG. 58, the spacer 305 comprises a ring which extends round a majority of a circumference of the wafer. The open centre of the ring provides a sample chamber 303 shown in FIG. 59. The ring is broken by a channel 309 which provides an inlet which extends from the outer edge of the sample chamber 303 to the edge of the wafer 300 as shown in FIG. 54.

The inner wall of the spacer 305 provides an edge wall of the sample chamber 303. The edge wall provides a boundary of the sample chamber 303 at its outer edge, preventing the biological sample from leaking out of the outer edge of the sample chamber 303.

The channel 309 provides an opening in the edge wall of the sample chamber 303 for introduction of the sample.

The upper disc 301 has a vent hole 306 which enables air to escape as a sample is introduced into the sample chamber 303 via the channel 309.

The size of the gap between the discs in the sample chamber 303 is carefully selected so that a liquid biological sample introduced into the sample chamber 303 is drawn further into the sample chamber by the capillary effect to form a smear. This gap size is controlled by the thickness of the spacer 305. Suitable gap sizes are given in Table 1.

By way of non-limiting example, the spacer 305 may be formed from a super-thin double-coated adhesive tape, such as Nitto Denko No. 5601, which has a thickness of 10 μm (0.01 mm). This particular tape is formed from a polyester film and acrylic adhesive on each side. A product datasheet is available at:

https://www.nitto.com/eu/en/others/products/file/datasheet/NJ_No5601_EN.pdf

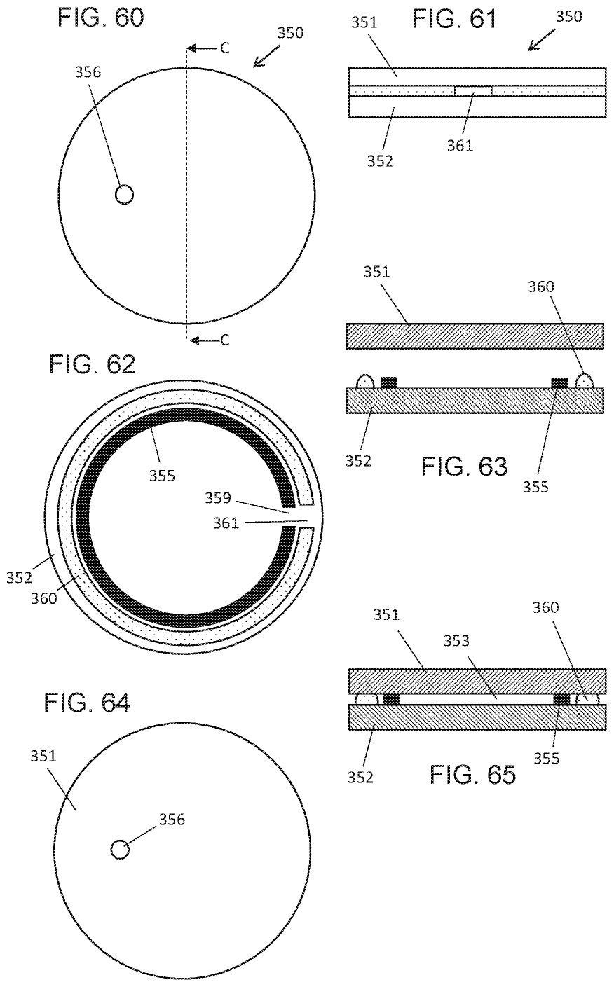

An alternative wafer 350 shown in FIGS. 60-65 comprises a pair of plates in the form of a pair of circular discs 351, 352. FIG. 63 shows the discs 351, 352 before they are brought together. The inner faces of the discs are shown in FIGS. 62 and 64.

The inner face of the lower disc 352 is printed with a spacer 355. The spacer 355 may be printed on the inner face of the lower disc 352 by a precision printing technique, such as screen printing, which enables the spacer 355 to be printed with a well defined and uniform thickness, for instance 10 μm, or 15 μm.

As shown in FIG. 62, the spacer 355 comprises a ring which extends round a majority of a circumference of the wafer. The open centre of the ring provides a sample chamber 353 shown in FIG. 65. The cylindrical inner wall of the printed spacer 355 provides an edge wall of the sample chamber 353, which provides a boundary of the sample chamber 353 at its outer edge. The edge wall prevents the biological sample from leaking out of the outer edge of the sample chamber 353.

The ring comprises an inlet channel 359 which provides an inlet which extends from the outer edge of the sample chamber 353. The inlet 359 provides an opening in the edge wall of the sample chamber 353 for introduction of the sample.

The discs are adhered to each other by an adhesive 360. As shown in FIG. 62, the adhesive 360 comprises a ring which extends round a majority of a circumference of the wafer. The ring comprises a channel 361 which provides an inlet into the outer edge of the chamber 353 from the edge of the wafer 350 as shown in FIG. 61.

The adhesive 360 is applied as an extruded bead of liquid shown in FIG. 63. The upper disc 361 is then fitted in contact with the spacer 355, squashing the bead of liquid adhesive so that it spreads out as shown in FIG. 65. The adhesive is then cured to adhere the discs together.

The upper disc 351 has a vent hole 356 which enables air to escape as a sample is introduced into the chamber 353 via the channels 359, 361.

The size of the gap between the discs in the chamber 353 is carefully selected so that a liquid biological sample introduced into the chamber 353 is drawn further into the chamber by the capillary effect to form a smear. This gap size is controlled by the thickness of the spacer 355. Suitable gap sizes are given in Table 1.

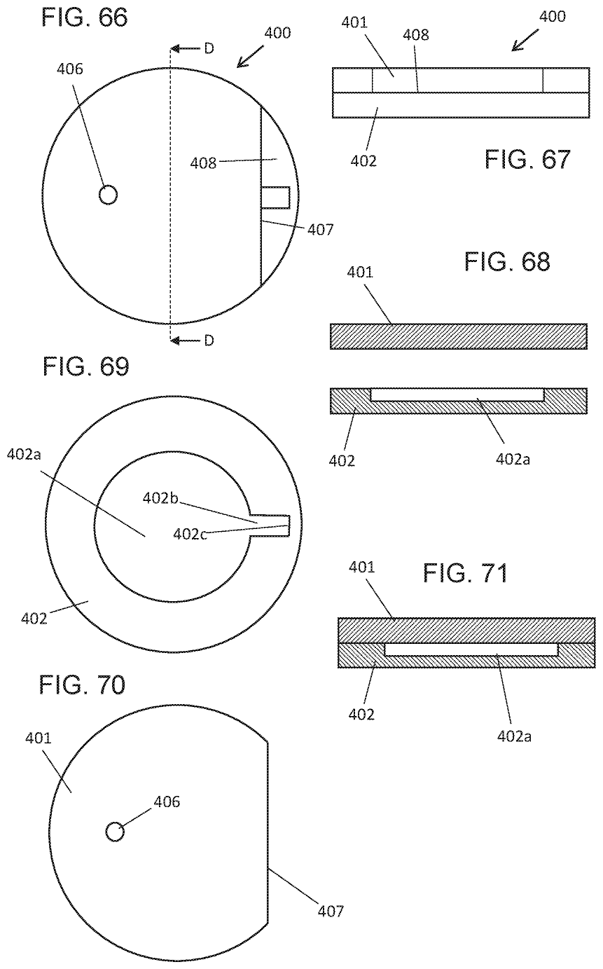

An alternative wafer 400 shown in FIGS. 66-71 comprises a pair of plates in the form of a pair of circular discs 401, 402. FIG. 68 shows the discs 401, 402 before they are brought together.

The discs 401, 402 have circular edges which overlap with each other except at the inlet where an edge of the upper disc 401 is cut-away to form a straight edge 407. The exposed inner face of the lower disc 402 provides a ledge 408 adjacent to the inlet channel 401b.

The inner faces of the discs are shown in FIGS. 69 and 70. The inner face of the lower disc 402 is formed with a circular sample recess 402a and an inlet well 402b extending from the circular sample recess 402a. The inlet well 402b provides an inlet recess which extends radially away from the edge of the sample recess 402a to an end wall 402c.

The sample recess 402a and the inlet well 402b may be formed by etching (for instance laser cutting), by hot-embossing or by any other suitable process.

The inner faces of the discs 401, 402 are joined together by ultrasonic welding or thermal welding.

The upper disc 401 has a vent hole 406 opposite the inlet well 402b. The vent hole 406 enables air to escape as a sample is introduced into the sample recess 402a via the inlet well 402b.

The circular sample recess 402a provides a sample chamber. The cylindrical wall of the sample recess 402a provides an edge wall of the sample chamber, which provides a boundary of the sample chamber at its outer edge. This edge wall prevents the biological sample from leaking out of the outer edge of the sample chamber. The inlet well 402b provides an opening in the edge wall through which the sample can be introduced into the sample recess 402a.

The depth of the sample recess 402a (which defines the gap size between the discs in the sample chamber) is carefully selected so that a liquid biological sample introduced into the edge of the sample recess 402a via the inlet well 402b is drawn further into the sample recess 402a by the capillary effect to form a smear. Suitable gap sizes are given in Table 1.

The ledge 408 may be used to support a finger or injection device as a sample is introduced into the inlet well 402b. The sample pools in the inlet well 402b and is drawn by capillary action from the inlet well 402b into the outer edge of the sample recess 402a between the discs.

In previous embodiments, the sample is introduced into the gap via an inlet which extends from the edge of the sample chamber and all the way to the edge of the wafer. In the wafer 400, the sample is introduced into the gap via an inlet well 402 which extends from the edge of the gap (i.e. the edge of the sample recess 402a) but stops at the end wall 402c of the inlet well 402, which is inset from the edge of the wafer 400.

The end wall 402c of the inlet well 402b prevents the sample from leaking off the edge of the wafer. In an alternative embodiment, the inlet well 402b may be replaced by an inlet recess which runs all the way to the edge of the lower disc 402, with no end wall.

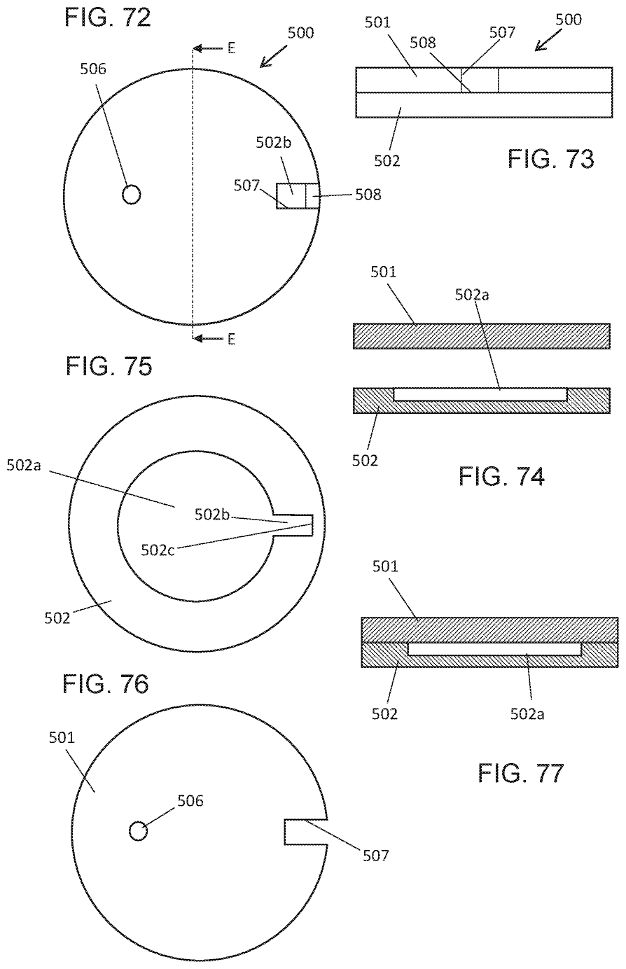

An alternative wafer 500 shown in FIGS. 72-77 comprises a pair of plates in the form of a pair of circular discs 501, 502. FIG. 74 shows the discs 401, 402 before they are brought together.

The inner faces of the discs are shown in FIGS. 75 and 76. The inner face of the lower disc 502 is formed with a circular sample recess 502a and an inlet well 502b extending from the circular sample recess 502a. The inlet well 502b extends radially away from the edge of the sample recess 502a to an end wall 502c and provides an inlet recess leading into the edge of the sample recess 502a.

The sample recess 502a and the inlet well 502b may be formed by etching (for instance laser cutting), by hot-embossing or by any other suitable process.

The edge of the upper disc 501 is cut-away to form an inlet notch with a pair of parallel edges 507 which run from the circular periphery of the upper disc 501 to the outer edge of the sample recess 502a.

The inner faces of the discs are joined together by ultrasonic welding or thermal welding.

The upper disc 501 has a vent hole 506 opposite the inlet notch. The vent hole 506 enables air to escape as a sample is introduced into the sample recess 502a.

The sample pools in the inlet well 502b and is drawn by capillary action into the sample recess 502a between the discs.

The end wall 502c of the inlet well 502b prevents the sample from leaking off the edge of the wafer. In an alternative embodiment, the inlet well 502b may be replaced by an inlet recess which runs all the way to the edge of the lower disc 502, with no end wall.

The size of the gap between the discs in the sample recess 502a is carefully selected so that a liquid biological sample introduced into the sample recess 502a is drawn further into the sample recess by the capillary effect to form a smear. This gap size is controlled by the depth of the sample recess 502b. Suitable gap sizes are given in Table 1.

The circular edges of the discs shown in FIGS. 75 and 76 overlap with each other except at the inlet notch where the inner face of the lower disc 502 provides a ledge 508 shown in FIGS. 72 and 73. The ledge 508 may be used to support a finger or injection device as a sample is introduced into the edge of the sample recess 502a via the inlet well 502b.

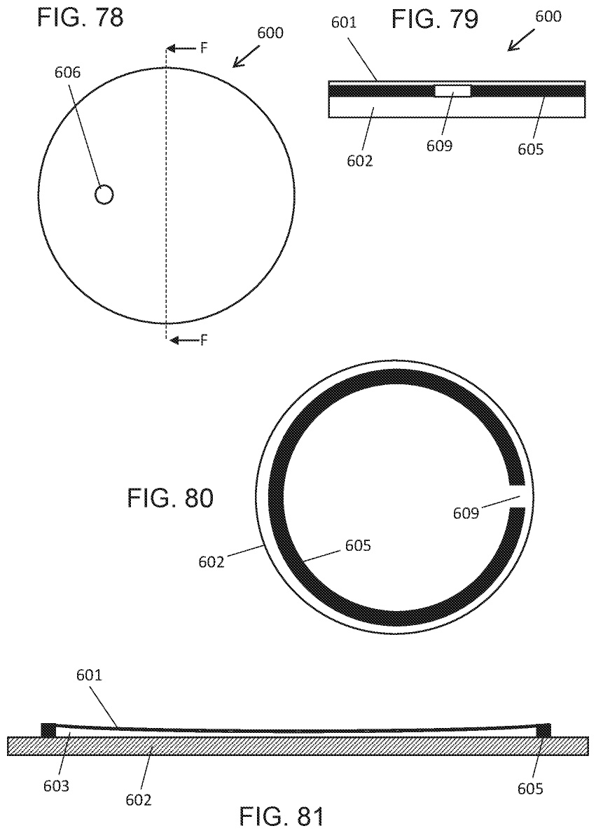

An alternative wafer 600 shown in FIGS. 78-81 comprises a pair of plates in the form of a pair of circular discs 601, 602.

The discs are adhered to each other by a double-sided adhesive spacer 605. As shown in FIG. 80, the spacer 605 comprises a ring which extends round a majority of a circumference of the wafer. The open centre of the ring provides a sample chamber 603 shown in FIG. 81.

The cylindrical inner wall of the spacer 605 provides an edge wall of the sample chamber 603, which provides a boundary of the sample chamber 603 at its outer edge. This edge wall prevents the biological sample from leaking out of the outer edge of the sample chamber 603. The ring comprises a channel 609 which provides an inlet into the edge of the sample chamber 603. The inlet extends from the edge of the sample chamber 603 as shown in FIG. 80. The inlet channel 609 comprises an opening in the edge wall of the sample chamber 603.

The upper disc 601 is formed from a thin and flexible polymer material (such as acrylic or polypropylene) which sags at its centre under its own weight as shown in FIG. 81. This sagged shape causes a size of the gap between the discs to increase in a radial direction away from a centre of the wafer 600, to a maximum at the outer edge of the sample chamber 603. The gap size increases monotonically away from the centre of the wafer, i.e. it increases without decreasing. The sample chamber is rotationally symmetrical so the gap size does not vary circumferentially.

The upper disc 601 has a vent hole 606 which enables air to escape as a sample is introduced into the edge of the sample chamber 603.

The size of the gap between the discs in the sample chamber 603 is carefully selected so that a liquid biological sample introduced into the sample chamber 603 is drawn further into the sample chamber by the capillary effect to form a smear. The maximum gap size at the edge of the chamber 603 is controlled by the thickness of the spacer 605. Suitable minimum or maximum gap sizes are given in Table 1.

The size of the gap varies from a maximum gap size at the outer edge of the sample chamber to a minimum at the centre of the wafer. The ratio between the maximum and minimum gap sizes in this case is about 2—in other words the maximum gap size is about twice the minimum gap size. The ratio between the maximum and minimum gap sizes may be greater than 1.1, greater than 1.3 or greater than 1.5 for example.

By way of non-limiting example, the spacer 605 may be formed from a super-thin double-coated adhesive tape, such as Nitto Denko No. 5601.

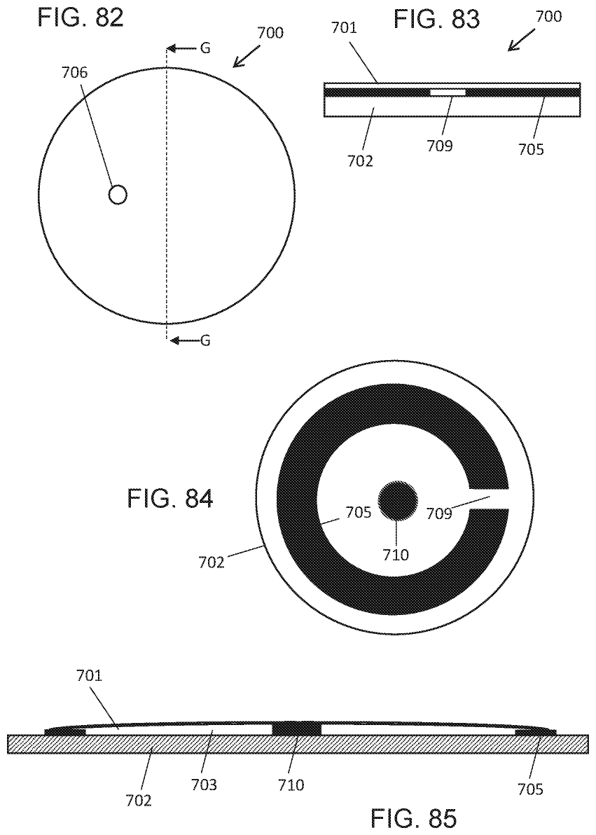

An alternative wafer 700 shown in FIGS. 82-85 comprises a pair of plates in the form of a pair of circular discs 701, 702.

The discs are adhered to each other by a double-sided adhesive spacer 705 and a central patch 710 of double-sided adhesive. As shown in FIG. 84, the spacer 705 comprises a ring which extends round a majority of a circumference of the wafer. The open centre of the ring provides a chamber 703 shown in FIG. 85. The ring is broken by an inlet channel 709 which provides an inlet extending from the edge of the chamber 703 as shown in FIG. 84.

The upper disc 701 is formed from a thin and flexible polymer material (such as acrylic or polypropylene). The upper disc 701 is initially flat, then deformed during fitting to form the deformed shape shown in FIG. 85. The spacer 705 is thinner than the central patch 710 so the upper disc 701 droops towards its edge, as shown in FIG. 85, during the fitting process. This drooped shape causes a size of the gap between the discs to decrease in a radial direction away from a centre of the wafer 700, to a minimum at the outer edge of the chamber 703. The gap size decreases monotonically away from the centre of the wafer, i.e. it decreases without increasing. The sample chamber is rotationally symmetrical so the gap size does not vary circumferentially.

The upper disc 701 has a vent hole 706 which enables air to escape as a sample is introduced into the chamber 703.

The size of the gap between the discs in the chamber 703 is carefully selected so that a liquid biological sample introduced into the chamber 703 is drawn further into the chamber by the capillary effect to form a smear. The minimum gap size at the edge of the chamber 703 is controlled by the thickness of the spacer 705 and the maximum gap size at the centre of the chamber 703 is controlled by the thickness of the central patch 710. Suitable minimum or maximum gap sizes are given in Table 1.

The size of the gap varies from a maximum gap size at the inner edge of the sample 50 chamber to a minimum at the outer edge of the sample chamber. The ratio between the maximum and minimum gap sizes in this case is about 2—in other words the maximum gap size is about twice the minimum gap size. The ratio between the maximum and minimum gap sizes may be greater than 1.1, greater than 1.3 or greater than 1.5 for example.

The outer part of the upper face of the lower disc 702 provides an annular ledge. A portion of the annular ledge adjacent to the inlet channel 709 can be used to support a finger or injection device.

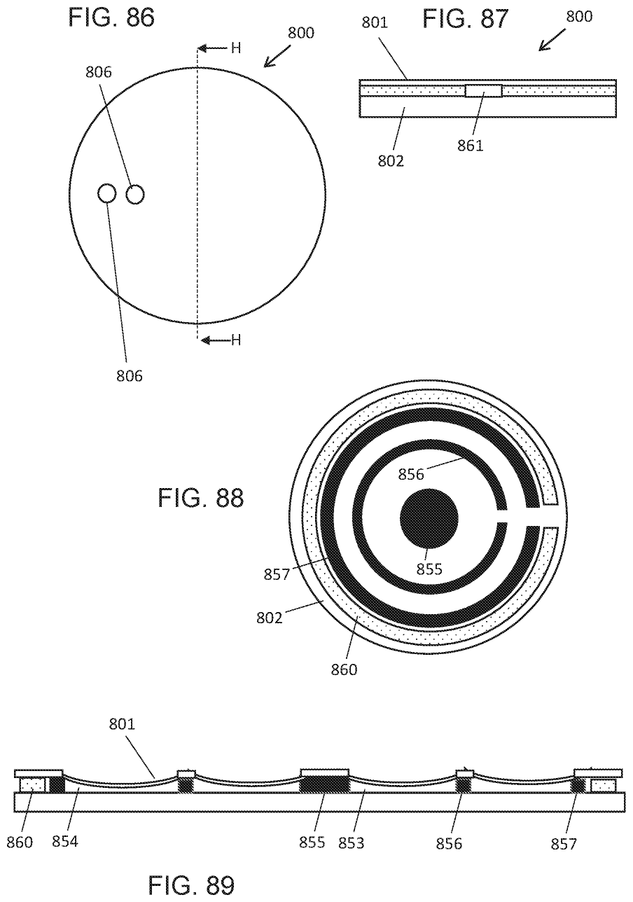

An alternative wafer 800 shown in FIGS. 86-89 comprises a pair of plates in the form of a pair of circular discs 801, 802.

The inner face of the lower disc 802 is printed with three spacers 855, 856, 857. The spacers 855-857 may be printed on the inner face of the lower disc 802 by a precision printing technique, such as screen printing, which enables the spacers to be printed with a well defined and uniform thickness, for instance 10 μm, or 15 μm.

As shown in FIG. 88, each spacer 856, 856, 857 comprises a ring which extends round a majority of a circumference of the wafer. The open centre of the spacer 856 provides a central chamber 853. The open centre of the spacer 857 provides an outer chamber 854. Each ring has a respective channel which provides an inlet into the edge of a respective chamber.

The discs are adhered to each other by an adhesive 860. As shown in FIG. 88, the adhesive 860 comprises a ring which extends round a majority of a circumference of the wafer. The ring comprises a channel 861 shown in FIG. 87 which provides an inlet into the edge of the chambers 853, 854.

The adhesive 860 is applied as an extruded bead of liquid. The upper disc 801 is then fitted in contact with the spacers 855-857, squashing the bead of liquid adhesive so that it spreads out. The adhesive is then cured to adhere the discs together.

The upper disc 801 is formed from a thin and flexible polymer material (such as acrylic or polypropylene). The upper disc 801 is initially flat, then deforms under its own weight to form the deformed shape shown in FIG. 89. This deformed shape causes a size of the gap between the discs to vary within each sample chamber 853, 854 in a radial direction away from a centre of the wafer 800 as shown in FIG. 89. Each sample chamber is rotationally symmetrical so the gap size does not vary circumferentially.

The upper disc 801 has a pair of vent holes 806. Each vent hole 806 enables air to escape from a respective one of the chambers 853, 854.

The size of the gap between the discs in the chambers 853, 854 is carefully selected so that a liquid biological sample introduced into the chambers 853, 854 is drawn further into the chambers by the capillary effect to form a smear. The maximum gap size at the edges of the chambers is controlled by the printing thickness of the spacers 855-857. Suitable minimum or maximum gap sizes are given in Table 1.

For each sample chamber the size of the gap varies from a maximum gap size at the outer edges of the sample chamber to a minimum at the centre of the sample chamber. The ratio between the maximum and minimum gap sizes in this case is about 2—in other words the maximum gap size is about twice the minimum gap size. The ratio between the maximum and minimum gap sizes may be greater than 1.1, greater than 1.3 or greater than 1.5 for example.

As described above, a biological sample is loaded into the wafer by introducing the sample into the gap so that the sample is pulled into the gap by capillary action. In some examples, one or both of the discs has an opening which provides an inlet into the gap, and the sample is introduced into the gap via the opening.

In some of the embodiments described above, each disc has a circular periphery at an edge of the wafer (for example edges 2a, 3a in the case of FIG. 3), and the gap has a circular open outer periphery at an edge of the wafer. The circular open outer periphery of the gap either extends around all of a circumference of the wafer, or around most of the circumference where spacers are provided at the edge of the wafer (such as the spacers 13-15 in FIG. 4).

Note that the Figures are not to scale, the size of the gap being exaggerated in the Figures to make the gap visible.

In the cases where an inlet 67, 77, 87, 97, 204, 309, 361, 401b, 609, 709, 861 is not provided, then the biological sample can be loaded into the wafer by introducing the sample into the edge of the gap at any point around the circumference of the wafer. Where an inlet 67, 77, 87, 97, 204, 309, 361, 401b, 609, 709, 861 is provided, the inlet may help to load more of the sample into the gap, and/or may help break the surface tension of the sample which make it easier to introduce into the gap.

In the cases where an inlet is not provided (i.e. the embodiments of FIGS. 1-16, and FIGS. 38-45) then inlets similar to the inlets 67, 77, 87, 97 may optionally be added.

In the Figures, the gap is an air gap, but optionally the gap may contain a stain, dye or other reagent which fully or partially fills the gap. The sample then comes into contact with the dye or reagent as it is pulled into the gap.

In some implementations, the dye is a dry dye. In some implementations, the dry dye includes methylene blue and/or eosin, cresyl violet or some other staining product, including those related to immunofluorescence assays.

The dye or other reagent(s) can be provided in the gap in a various ways. In one example, a small quantity of dye (e.g., about 5 uL of the dye) is loaded into the gap before the sample, so the sample comes into contact with the dye as it flows into the gap. In another example, stain, dye or other reagent is mixed with the sample before the sample is loaded into the gap. In another example, the stain, dye or other reagent is smeared on the internal face of one or both of the disks by a traditional smearing mechanism or spraying, before the wafer is assembled by bringing the discs together.

In some implementations, an external test tube is configured with anticoagulant to prepare a stained sample as an intermediate step before depositing the sample in the wafer.

Examples of biological samples which can be loaded into the wafer include: whole blood; sub-products of blood such as buffy coat, plasma or red blood cells; fine needle biopsy samples (e.g. surgical biopsy, fine needle biopsy, etc.); urine; semen; amniotic fluid; saliva; milk; bronchial lavage; cerebrospinal fluid; peritoneal fluid; faeces; bone marrow; serum; sputum; synoidal fluid; tears; vaginal fluid; nasal fluid; sweat; pleural fluid; tissue explant; organ culture; cell culture; or any other tissue or cell preparation, or fraction or derivative thereof or isolated therefrom. The sample may be from a host organism.

For all of the embodiments above, the upper disc is transparent (for instance made of glass or acrylic material) and the lower disc is either transparent, opaque or reflective. This enables the sample to be imaged by a camera through the upper disc. If the lower disc is also transparent (for instance made of glass or acrylic material) then the sample can be lit from below through the lower disc.

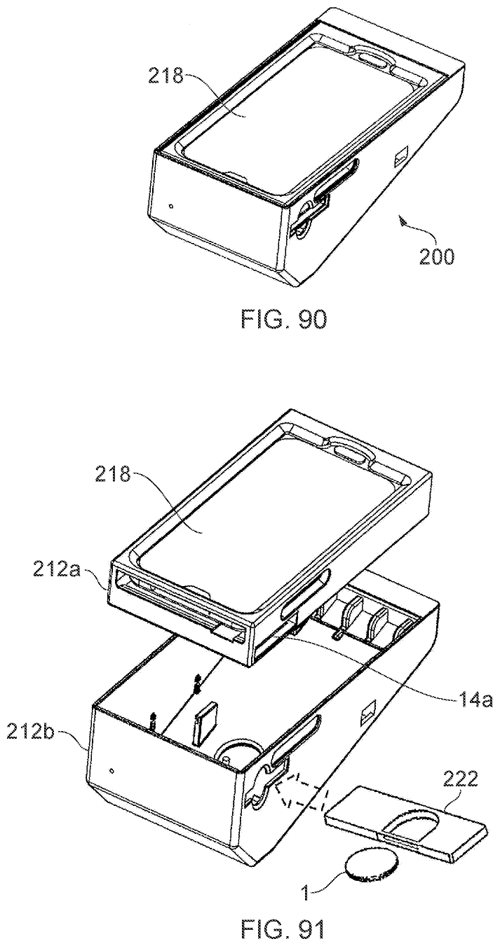

Once the wafer has been loaded with a biological sample, then a portable device 200 shown in FIG. 90 may be used to image the biological sample in the gap. The portable device comprises a camera 218; and a casing configured to receive the wafer at an imaging location inside the casing. As shown in FIG. 91, the casing consists of a top part 212a and bottom part 212b. The camera 218 may be a smartphone, for example.

Inside the casing, a rotary driver (not shown) is configured to rotate the wafer at the imaging location between a series of orientations, each orientation bringing a different area of the biological sample into a field of view of the camera.

A cartridge 222 shown in FIG. 91 carries the wafer 1. The cartridge 222 has a window and a slot through which the wafer 1 can be slid into the window where it is supported from below by a ledge. The cartridge 222 carrying the wafer 1 is then inserted into the casing 212a, 212b via a slot in the casing as indicated.

The compact circular shape of the above-described wafers makes them particularly suited for use in such a portable device 200. The rotational symmetry of the wafer allows a simplified mechanism to operate and drive the sample with a single actuator.

In other embodiments, any of the above-mentioned wafers may be modified so that they have a non-circular edge (such as a rectangular edge). Such non-circular wafers may be used in a device which scans the sample by a translational movement. This is less preferred because it requires more room to scan the same sample and makes it more difficult for the design of a portable device with limited space.

1. A wafer for carrying a biological sample, the wafer comprising: a pair of plates or circular discs, wherein at least one of the plates or circular discs is transparent; and a gap between the plates or circular discs adapted to receive a biological sample, wherein the gap is sized to pull a biological sample into the gap by capillary action.

2-14. (canceled)

15. The wafer of claim 1, further comprising an inlet into the gap.

16. The wafer of claim 15, wherein the inlet extends to an edge of the wafer.

17. (canceled)

18. (canceled)

19. The wafer of claim 15, wherein an inner face of a lower one of the discs provides a ledge adjacent to the inlet.

20. The wafer of claim 1, wherein the gap comprises a sample chamber.

21. The wafer of claim 20, wherein the sample chamber comprises an edge wall which provides a boundary of the sample chamber at its outer edge.

22-24. (canceled)

25. The wafer of claim 1, further comprising one or more spacers between the discs or plates.

26. The wafer of claim 25, wherein the one or more spacers comprise an adhesive tape.

27. The wafer of claim 25, wherein the one or more spacers comprise a spacer with an opening which provides an inlet into the gap.

28. The wafer of claim 27, wherein the spacer comprises a ring which is broken by the opening.

29. The wafer of claim 25, wherein the one or more spacers control a size of the gap.

30. (canceled)

31. (canceled)

32. The wafer of claim 1, wherein a size of the gap is less than 20 μm.

33-40. (canceled)

41. The wafer of claim 1, wherein a size of the gap varies in a radial direction away from a centre of the wafer.

42. A wafer for carrying a biological sample, the wafer comprising: a pair of circular discs, wherein at least one of the discs is transparent; and a gap between the discs adapted to receive a biological sample, wherein a size of the gap varies in a radial direction away from a centre of the wafer.

43. The wafer of claim 42, wherein the size of the gap increases in the radial direction away from the centre of the wafer.

44. The wafer of claim 42, wherein the pair of circular discs comprise an upper disc and a lower disc, and the upper disc is sagged at the centre of the wafer or drooped at an edge of the upper disc.

45-52. (canceled)

53. A method of manufacturing a wafer according to claim 1, the method comprising bringing the discs or plates together to provide the gap between the discs; and fixing the discs or plates together.

54. (canceled)

55. The method of claim 53, the wafer comprising an upper disc or plate, and a lower disc or plate with one or more spacers which control the size of the gap, the discs or plates being held together by an adhesive; wherein when the discs or plates are brought together, the adhesive spreads out until the one or more spacers contact an underside of the upper disc or plate; and the adhesive is then cured to secure the discs or plates together.

56. The method of claim 53, further comprising printing one or more spacers on one of the discs or plates, wherein the one or more spacers control a size of the gap.

57. The method of claim 53, further comprising deforming one of the discs or plates so that a size of the gap varies across the wafer.

58. (canceled)

59. (canceled)
